(19) United States
(12) Patent Application Publication
(10) Pub. No.: US 2002/0158770 A1
(43) Pub. Date: Oct. 31, 2002

(54) Apparatus and method for communicating configuration information in a computer system

(76) Inventors: Shakil Ahmed, Newark, CA (US); David A. Rudy, Austin, TX (US); Denise Silverman, San Carlos, CA (US); Timothy E. Mautz, San Anselmo, CA (US); Raymond K. Ho, San Jose, CA (US)

Correspondence Address: Daniel Vaughan, Park, Vaughan & Fleming LLP, 702 Marshall Street, Suite 310, Redwood City, CA, 94063, US

(21) Appl. No.: 09/844,844

(22) Filed: Apr. 27, 2001

(51) Int. Cl. G08B 21/00

(52) U.S. Cl. 340/686.4; 340/635; 439/490

(57) ABSTRACT

An apparatus and method for communicating configuration information are disclosed. A live insertion device has a status, or configuration, such as a state of readiness to be removed from a powered up computer and a state of readiness to operate. The removal readiness may include factors such as whether the live insertion device is related to ongoing processes, such that immediate removal would cause errors. The operational readiness may includes factors such as whether the relevant software is ready and whether the live insertion device can function. The live insertion device also has a seating state, such as whether the live insertion device is properly physically positioned in or coupled to the computer. Prior to an attempt at removing and/or operating the live insertion device, the configuration state of the live insertion device can be verified via an indicator that receives the configuration information about the live insertion device.

### FIELD OF THE INVENTION

The field of the invention generally includes live insertion and removal, for example hot plugging and/or hot swapping, of field replaceable units (FRUs) into and out of a server. More particularly, this invention pertains to a service indicator that communicates a FRU's configuration status.

### BACKGROUND OF THE INVENTION

In many server systems, a critical requirement is the maximization of reliability and the minimization of server downtime. FRUs can be designed with these goals in mind, thereby simplifying the process of replacing defective hardware and upgrading old hardware. Standards for live insertion, such as hot plugging and hot swapping, can allow the insertion and removal of peripherals while the server is powered up and running.

Present standards for live insertion still leave room for improvement, however. Hot plugging or hot swapping ability enables a FRU to become operational after being inserting into a powered server. However, after the FRU is physically added to the server, there may not be any readily perceptible external indicator that communicates when the FRU has become operational. Similarly, there may not be any indication that the FRU may safely be removed without disrupting an ongoing process. In either situation—attempting to use the capabilities of the FRU before the FRU is operationally ready, or attempting to remove the FRU while the FRU is being used—errors may result, ranging from the generation of error messages to a server crash.

Present external indicators may not solve these problems. For example, a light on a drive may simply indicate that the drive is presently active, reading and/or writing data. However, the drive light may not indicate whether an attempt to read or write data will cause errors. Further, assuming that the drive was hot plug or hot swap compliant, the drive light may not indicate whether an attempt to remove the drive from the system will cause errors or interrupt an active process not indicated by the drive light.

Thus, it would be desirable to indicate a status of a FRU, beyond merely whether the FRU is actively reading or writing data or trying to read or write data.

### SUMMARY

To overcome the limitations described above, and to overcome other limitations that will become apparent upon reading and understanding the present specification, the present invention discloses a live insertion system with a live insertion device and an indicator that corresponds to a configuration of the live insertion device. For example, the live insertion device may have a configuration state such as an operational readiness, a removal readiness, and/or a seating state. Configuration logic can communicate this configuration information from the live insertion device to the indicator.

In another embodiment, the live insertion system includes an operating system and a device driver for receiving configuration information about the live insertion device and communicating it through an exterior of the live insertion device.

In another embodiment, the live insertion system includes substantial hardware and substantial software components.

A method embodiment receives configuration information about the live insertion device and communicates the configuration information through an exterior of the live insertion device.

### DESCRIPTION OF THE DRAWINGS

FIG. 1 is a diagram of an exemplary configuration system including a presence module and a configuration module;

FIG. 2 is a diagram of an exemplary hardware implementation of the configuration system of FIG. 1;

FIG. 3 is a diagram of an exemplary software implementation of the configuration system of FIG. 1;

FIG. 4 is a diagram of an exemplary implementation of the configuration system of FIG. 1 including substantial hardware and software components; and

FIG. 5 is a flow diagram of an exemplary method of communicating a configuration a configuration state of a live insertion device.

### DETAILED DESCRIPTION

One or more embodiments are described in a preferred embodiment in the following description with reference to the Figures, in which like numbers represent the same or similar elements. While the description is in terms of the best mode for achieving one or more objectives, it will be appreciated by those skilled in the art that variations may be accomplished in view of those teachings without deviating from the spirit or scope of the described embodiments.

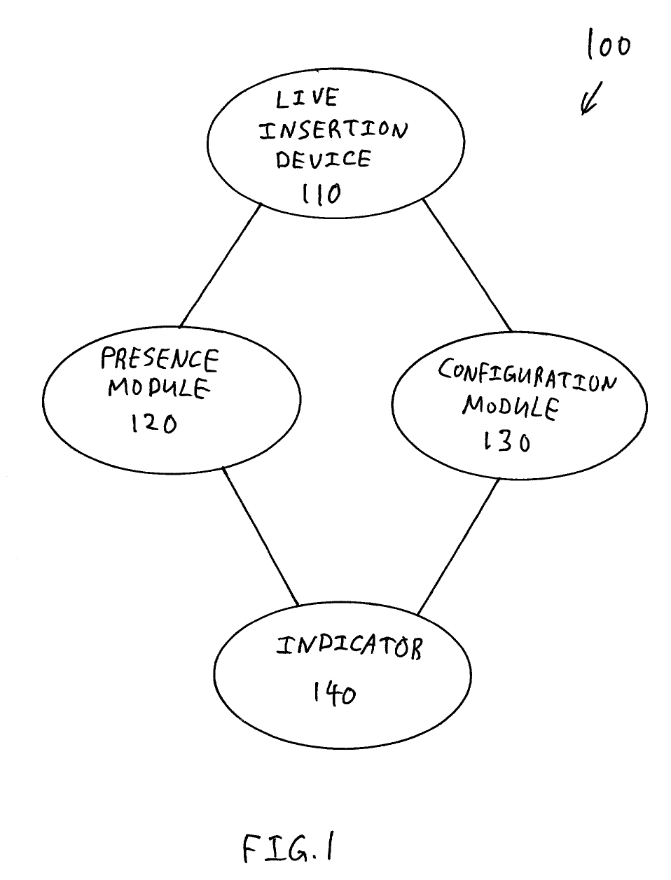

FIG. 1 illustrates a block diagram of a configuration system 100. A live insertion device 110 is coupled to a presence module 120 and a configuration module 130. An indicator 140 is coupled to the presence module 120 and the configuration module 130.

The live insertion device 110 can be exchanged in and out of a computer without powering down the computer. The live insertion device 110 may be a data storage peripheral, such as a drive using magnetic, electrical, and/or optical technology. The live insertion device 110 may comply with a standard such as SCSI, ATA, IDE, and DMA.

The presence module 120 receives information about the physical installation of the live insertion device 110. For example, the live insertion device 110 may or may not be completely seated in a computer, may not be configured, or may not be recognized. The presence module 120 can receive information about the seating of the live insertion device 110 in the computer. If the live insertion device 110 is not operational due to a problematic physical installation, then the presence module 120 can send a signal to the indicator 140. For example, if the live insertion device 110 is not fully seated, and consequently lacks sufficient electrical, optical, and/or magnetic contact, direct or wireless, with a backplane or other receiving component, the presence module 120 can send a signal indicating that the live insertion device 110 should be fully seated. Alternatively, the presence module can send a signal to the configuration module 130.

The configuration module 130 can receive information about a configuration of the live insertion device 110. For example, the status of the device driver, operating system errors, and operational readiness of the live insertion device 110, and/or removal readiness of the live insertion device 110 can be received by the configuration module 130 . One or more of these configuration states can be signaled via the indicator 140.

The indicator 140 visibly indicates the state of configuration information sent from the presence module 120 and/or the configuration module 130. The configuration system 100 can therefore signal via the indicator 140 information about the live insertion device 110, such as the physical installation, the device driver, relevant errors, the operational readiness, and/or the removal readiness. In one embodiment, the indicator 140 can provide visual information that, for example, the live insertion device 110 can be safely removed without causing downtime of a server. The indicator 140 may communicate information continuously, intermittently, or after prompting. Another embodiment of the indicator 140 provides an auditory cue about the configuration information provided by the presence module 120 and/or the configuration module 130. The indicator 140 may include one or more indicators having one or more modes to display various states, such as the live insertion device 110 not being installed; the live insertion device 110 being installed, configured, and operational; the live insertion device 110 being installed but not configured; and/or the live insertion device 110 being ready to remove without causing errors such as error messages or crashes. In one embodiment, the indicator 140 includes one or more LEDs having one or more colors, an off state, an on state. In another embodiment, one or more blinking rates to communicate configuration information about the live insertion device 110.

The shown modules are illustrative and exemplary. For example, the indicator 140 can be implemented independently, or integrated with the live insertion device 110. The configuration module 130 may incorporate one or more functions of the presence module 120, and/or vice versa. The configuration module 130 and/or the presence module 120 may be positioned with the live insertion device 110 or away from the live insertion device 110. The configuration system 100 can be implemented primarily in software, primarily in hardware, or with significant hardware and software components.

Depicted are some exemplary embodiments of hardware and/or software for the configuration module 130.

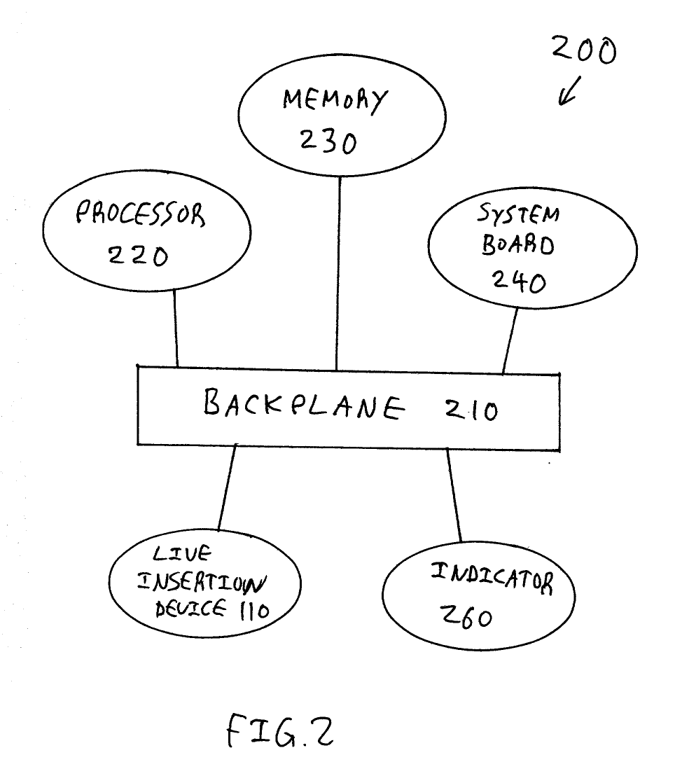

FIG. 2 shows a hardware system 200 that includes a backplane 210. The backplane couples together other hardware, such as a processor 220, a memory 230, a system board 240, the live insertion device 110, and an indicator 260. The functions of the presence module 120 and/or the configuration module 130 can be partially or completely implemented using one or more modules of the hardware system 200. The hardware system 200 can include live insertion ability, such as hot plug and/or hot swap technology. The backplane can include SCSI interfaces for one or more hardware components, such as the live insertion device 110, and may include Compact PCI technology. One example of the hardware system 200 is a Sun Microsystems™, Inc. Netra ct™ server. The shown hardware components are illustrative and exemplary. For example, the live insertion device 110 may include its own processing resources, lessening or removing the need for the central processing unit 220. The system board 240 may be unnecessary. Alternatively, the system board 240 may be present, and include the processor 220, the memory 230. The indicator 260 may be part of a status board having one or more indicators, or may be included in another component, such as the system board 240 or the live insertion device 110. The system board 240 may be replaced with a generic board, such as a generic input/output board.

In one embodiment, the system board 240 receives presence information about the live insertion device 110, and sends the information to the indicator 260. In another embodiment, the system board 240 receives information about the configuration or status of the device 110, and sends the information to the indicator 260. Other embodiments route the presence information at one or more of the processor 220, the memory 230, and the system board 240. In one embodiment, the processor 220 receives configuration information about the live insertion device 110 and sends the information to the indicator 260. Other embodiments route the configuration information at one or more of the processor 220, the memory 230, and the system board 240. The presence information and the configuration information may also travel directly between the live insertion device 110 and the indicator 260.

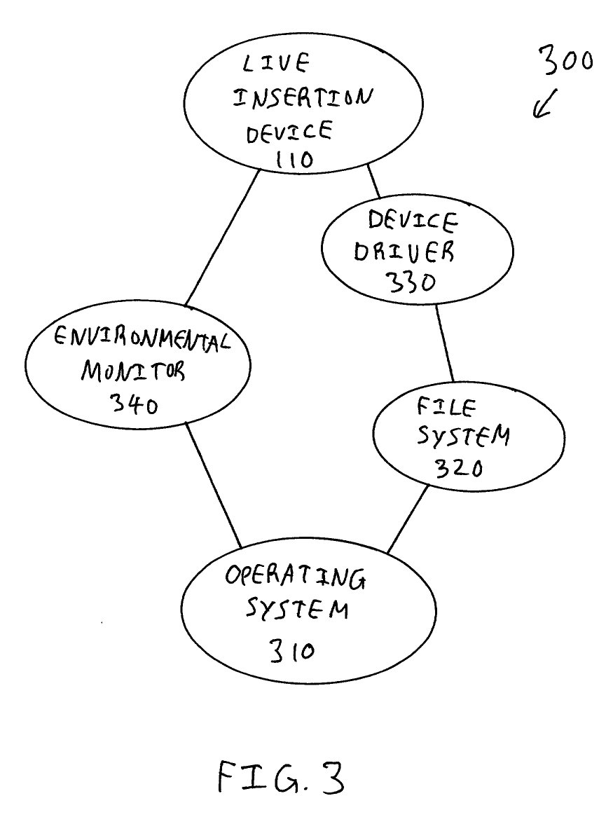

FIG. 3 shows a software system 300 that includes an operating system 310, a file system 320, a device driver 330, and an environmental monitor 340. The functions of the presence module 120 and/or the configuration module 130 can be partially or completely implemented using one or more modules of the software system 300. Some examples of the operating system 310 include various types of Unix, such as Solaris, HP-UX, SCO, and Linux; and Windows based operating systems, such as Windows NT and Windows 2000. The file system 320 can be related to the particular operating system or systems 310 chosen for the software system 300. One or more file systems 320 for the live insertion device 110 can be implemented. The indicator 140 may receive configuration information about one or more of the implemented file systems 320. For example, the indicator 140 can signal whether one, more, or all of the file systems 320 physically located on the live insertion device 110 are relevant to an existing or future process. The device driver 330 can expand the ability of the operating system 310 to work with one or more hardware components.

The shown software components are illustrative and exemplary. For example, the operating system 310 may include the functionality of the device driver 330, the file system 320, and/or the environmental monitor 340. One or more of the software components can run on one or more separate processors, or alternatively may run on processing resources that may be included with the live insertion device 110.

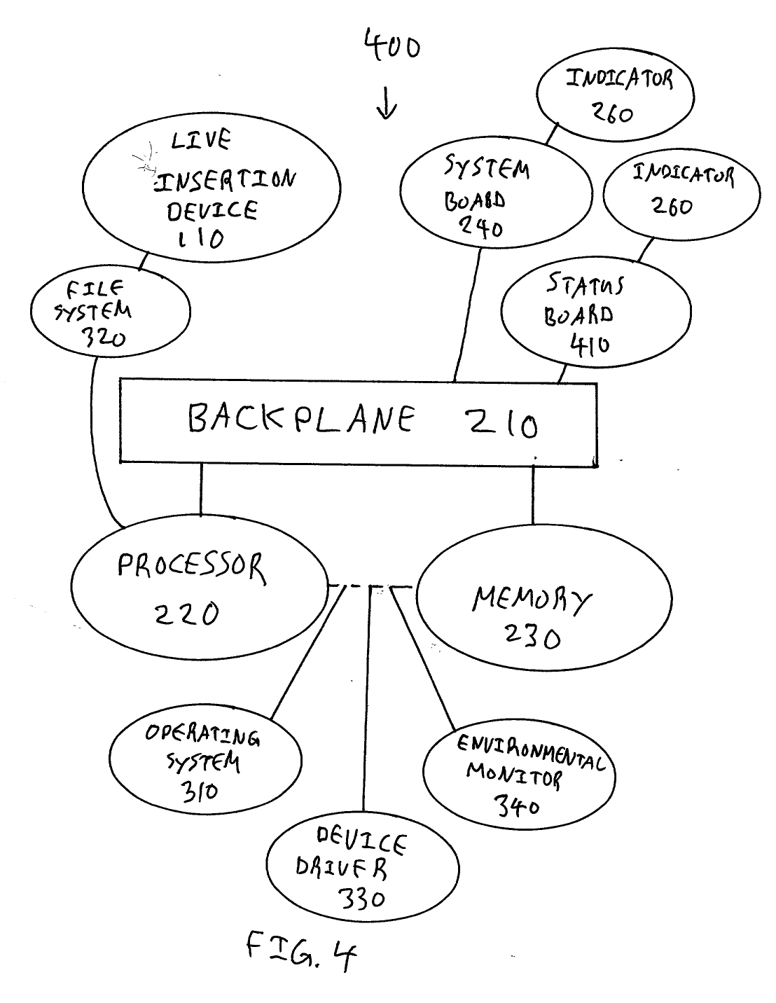

FIG. 4 shows a hardware and software system 400 that includes significant hardware and software components to implement functions of the presence module 120 and/or the configuration module 130. A backplane 210 is coupled to a live insertion device 110, a processor 220, a memory 230, a system board 240, and a status board 410. Indicators 260 exist on the system board 240 and/or the status board 410. A file system 320 exists at least on the live insertion device 110. An operating system 310, a device driver 330, and an environmental monitor 340 are supported at least by the processor 220. The shown hardware/software configuration is exemplary, and may rearranged and/or modified. For example, functionality of the environmental monitor 340 may already exist in the operating system 310 and/or the device driver 330.

In one embodiment, modifications may be made to the operating system 310 to add functionality of the presence module 120 and/or the configuration module 130. Other embodiments take advantage of the already hot-swap capable device driver 330.

One embodiment of the environmental monitor 340 uses Solaris for the operating system 310, while other embodiments use another operating system 310. The environmental monitor 340, also known as an environmental daemon, can detect and report configuration information about the live insertion device 110. In one embodiment, the environmental monitor is a software component that reads information from the presence module (typically hardware) and configuration module (typically software, for example the operating system, device driver and filesystem) and controls the indicators. The environmental monitor contains the intelligence to match each presence and configuration state to a unique indicator. The indicators include “present” and “ok to remove” lights and may contain other lights such as “fault” and “configuring”.

The configuration information is stored at many different places within the operating system, for example the filesystem(s), the device drivers and different busses (for example the SCSI bus). This information needs to be combined and correlated, hence the need for the environmental monitoring daemon or some similar process to relate the data to the underlying live insertion device.

In one embodiment, the environmental monitor 340 can use a driver specific interface via ioctl calls to control and update the indicators 260. In one embodiment, the environmental monitor 340 interacts via a scsb driver with the system board 240 to receive presence information and/or status information about the live insertion device 110. The scsb driver allows both applications and the operating system access to the presence module information.

Information specific to the live insertion device 110 can be obtained from the scsb driver via a kstat interface.

The environmental monitor 340 may use one or more policies, such as a SCSI policy. The policy can interact via libcfgadm with a dynamic configuration framework cfgadm to obtain configuration information about specific devices, relevant to the policy, such as SCSI devices.

The policy of the environmental monitor 340 may also interact with a device information framework, such as a pseudo driver devinfo, via libdevinfo interfaces to obtain current status information and/or presence information. In some embodiments, presence information is a subset of configuration information.

System events can change a configuration status, such as a live insertion or live removal, and/or file system attaching or detaching. Following a change in configuration status, the environmental monitor 340 can receive configuration information and/or presence information and send corresponding signals to the indicators 260. In one instance, the indicators 260 may show a status indicating that the live insertion device 260 should not be removed from the system 400, because the file system 320 is mounted and/or the device driver 330 is attached. In another instance, the indicators 260 may show a status indicating that the live insertion device 260 may be removed without causing an error, because the file system 320 is not mounted and the device driver 330 is not attached.

In one embodiment, the environmental monitor 340 polls for information. In another embodiment, the environmental monitor 340 is notified of configuration state information.

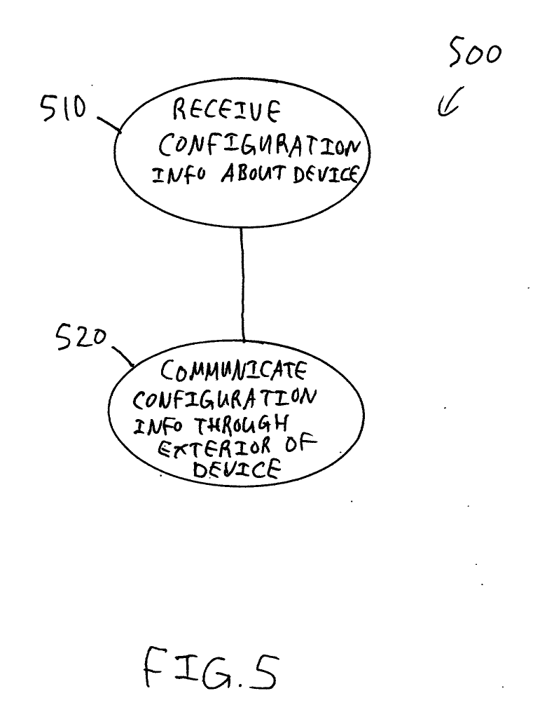

FIG. 5 shows an exemplary method 500 for communicating configuration information. In 510, configuration information is received about a device. The device may have live insertion capability, such as having hot swap or hot plug compatibility. In 520, the configuration information is communicated through an exterior of the live insertion device. The information may be communicated from an exterior source or an interior source, as long as the configuration information is communicated through the exterior of the live insertion device. For example, a light, a sound, or absence of the light or sound can originate from within an interior source, but be perceptible from the exterior. The exterior of the device may be interpreted as the exterior of the device itself, or the exterior of the housing enclosing the device. For example, if the device is enclosed in a server housing, the exterior of the device may refer to the exterior of the server housing.

While the preferred embodiments of the present invention have been illustrated herein in detail, it should be apparent that modifications and adaptations to those embodiments may occur to those skilled in the art without departing from the scope of the following claims.

1. A method of communicating a configuration state of a live insertion device, comprising:
receiving configuration information about the live insertion device; and
communicating the configuration information about the live insertion device through an exterior of the live insertion device.

2. The method of claim 1, wherein the configuration information includes an operational readiness of the live insertion device.

3. The method of claim 1, wherein the configuration information includes a removal readiness of the live insertion device.

4. The method of claim 1, wherein the configuration information includes a seating state of the live insertion device.

5. The method of claim 1, wherein communicating includes changing a state of an indicator positioned on the exterior of the live insertion device.

6. The method of claim 5, wherein changing the state of the indicator includes illuminating the indicator.

7. The method of claim 5, wherein changing the state of the indicator includes darkening the indicator.

8. The method of claim 5, wherein changing the state of the indicator includes changing a color of the indicator.

9. A live insertion system, comprising:
a live insertion device having a plurality of configurations;
an external housing supporting the live insertion device;
a visible indicator coupled to the external housing, wherein the visible indicator has one or more states corresponding to one or more of the plurality of configurations;
configuration logic coupled to the live insertion device and the visible indicator, wherein the configuration logic communicates information about a configuration of the live insertion device with the live insertion device and the visible indicator.

10. The live insertion system of claim 9, wherein the configuration information includes an operational readiness of the live insertion device.

11. The live insertion system of claim 9, wherein the configuration information includes a removal readiness of the live insertion device.

12. The live insertion system of claim 9, wherein the configuration information includes a seating state of the live insertion device.

13. A live insertion system for tracking a configuration of a live insertion device, comprising:
an operating system managing at least basic operations for a computer system; and
a device driver coupled to the operating system to control the live insertion device,
wherein the live insertion system receives configuration information about the live insertion device and communicates the configuration information about the live insertion device through an exterior of the live insertion device.

14. The system of claim 13, further comprising:
an environment presence module coupled to the operating system for detecting seating information of the live insertion device.

15. The live insertion system of claim 13, wherein the configuration information includes an operational readiness of the live insertion device.

16. The live insertion system of claim 13, wherein the configuration information includes a removal readiness of the live insertion device.

17. The live insertion system of claim 13, wherein the configuration information includes a seating state of the live insertion device.

18. A live insertion system, comprising:
a housing;
a processor supported by the housing;
a memory coupled to the processor;
a peripheral bus coupled to the processor;
a live insertion device coupled to the peripheral bus; and
an indicator supported by the housing for communicating configuration information,
wherein at least one of the processor and the memory have loaded: an operating system, a device driver for the live insertion device, and an environmental monitor for the live insertion device.

19. The live insertion system of claim 18, wherein the configuration information includes an operational readiness of the live insertion device.

20. The live insertion system of claim 18, wherein the configuration information includes a removal readiness of the live insertion device.

21. The live insertion system of claim 18, wherein the configuration information includes a seating state of the live insertion device.

22. A computer readable medium whose contents cause a computer system to perform the steps of:
receiving configuration information about a live insertion device; and
communicating the configuration information about the live insertion device through an exterior of the live insertion device.

23. The computer readable medium of claim 22, wherein the configuration information includes an operational readiness of the live insertion device.

24. The computer readable medium of claim 22, wherein the configuration information includes a removal readiness of the live insertion device.

25. The computer readable medium of claim 22, wherein the configuration information includes a seating state of the live insertion device.

26. A computer readable medium whose contents comprise:
an operating system managing at least basic operations for a computer system; and
a device driver coupled to the operating system to control a live insertion device, wherein at least one of the operating system and the device driver cause configuration information about the live insertion device to be communicated through an exterior of the live insertion device.

27. The computer readable medium of claim 26, wherein the configuration information includes an operational readiness of the live insertion device.

28. The computer readable medium of claim 26, wherein the configuration information includes a removal readiness of the live insertion device.

29. The computer readable medium of claim 26, wherein the configuration information includes a seating state of the live insertion device.

30. A live insertion system, comprising:
a live insertion device having a plurality of configurations and an exterior;
a configuration module coupled to the live insertion device, wherein the configuration module communicates information about a configuration of the live insertion device with the live insertion device; and
an indicator coupled to the exterior of the configuration module, wherein the indicator has one or more states corresponding to one or more of the plurality of configurations, and the indicator displays information about the configuration of the live insertion device with the live insertion device.

31. The live insertion system of claim 30, wherein the configuration information includes an operational readiness of the live insertion device.

32. The live insertion system of claim 30, wherein the configuration information includes a removal readiness of the live insertion device.

33. The live insertion system of claim 30, wherein the configuration information includes a seating state of the live insertion device.
